(19) United States
(12) Patent Application Publication
(10) Pub. No.: US 2012/0226557 A1
(43) Pub. Date: Sep. 6, 2012

(54) METHOD OF MARKETING USING MOBILE COMMUNICATION DEVICE

(75) Inventor: Rick A. Sigler, South Lyon, MI (US)

(73) Assignee: GRIFFIN WEB DEVELOPMENT, LLC, Brighton, MI (US)

(21) Appl. No.: 13/411,744

(22) Filed: Mar. 5, 2012

Related U.S. Application Data
(60) Provisional application No. 61/448,852, filed on Mar. 3, 2011.

(51) Int. Cl. G06Q 30/02

(52) U.S. Cl. 705/14.64; 705/14.66

(57) ABSTRACT

A method of marketing using mobile communication devices provides a computer database of market potentials. Fields associated with the computer database that are representative of demographic characteristics are established. Access is provided to the computer data base to consumers enabling consumers to populate the fields with characteristic demographic information. Access to the computer database is provided to businesses seeking to market goods and services to consumers having a predetermined demographic characteristic. The computer database is transformed into market segments defined by the business' predetermined market demographic and an electronic message is generated and transmitted to mobile communication devices owned by the consumers whose characteristic demographic information match the market segment defined by the business. Remuneration is provided to the consumer whose characteristic demographic information matches the market segment in response to the consumer receiving the electronic message.

This application claims priority to U.S. Provisional Patent Application No. 61/448,852 file on Mar. 3, 2011.

### BACKGROUND

The present invention relates generally toward a new method of marketing to consumers. More specifically, the present invention is related toward demographically marketing to consumers by way of mobile communication devices.

The increase in cost and segmentation of the various markets has made it exceedingly difficult and costly for businesses to market to potential customers at a reasonable cost. For example, consumer goods markets have become increasingly segmented requiring consumer product companies to diversify their portfolio of consumer goods to meet the segmented demands of the consumers. Difficulty arises when a consumer goods company or similar business wants to market its products in a conventional manner to each of its target market segments. To adequately focus a marketing campaign to an intended market segment using conventional advertising means such as, for example, newspapers, radio, television, or even the internet, a consumer products company is required to take out separate advertisements targeting its segmented product portfolio to communicate with its intended market segment. However, these advertisements used in conventional advertising venues cannot be targeted to a specific market segment, but are necessarily broadcast to a whole market. Businesses buying advertisements using old line advertising methods are required to pay for full market exposure while having no guarantee its intended target market segment is being reached.

Therefore, it has become necessary to find a way to focus advertising directly to the intended market segment, which heretofore has not been available by way of conventional marketing avenues.

### SUMMARY

The present invention relates generally to a method of marketing using mobile communication devices. A computer database is used to identify market potentials where data fields are associated with the computer database are established. The fields represent demographic characteristics of the market potentials. Access is provided to the computer database to the consumers enabling the consumers to populate the fields with characteristic demographic information. Access to the computer database is provided to businesses seeking to market goods and services to the consumers having a predetermined demographic characteristic. The computer database transforms consumer data into market segments defined by the business' predetermined market demographic. The business generates and transmits an electronic message to the mobile communication devices owned by the consumers whose characteristic demographic information matched the market segment defined by the business. Remuneration is provided to the consumer whose characteristic demographic information matches the market segment in response to the consumer receiving the electronic message.

The inventive method of the present application provides the business the ability to focus its marketing resources directly to a market segment having targeted demographics. Additionally, the remuneration provided to the consumer receiving the marketing message via a mobile communication device by way of a text message or equivalent enhances the ability of the business marketing its goods and services to be reviewed by the consumer. In this manner, the consumer products business does not waste marketing resources and capital by sending advertising messages to market segments having uninterested demographics. This provides the benefit to the consumer as well as to the consumer products business increasing the probability of a successful marketing campaign to an interested consumer.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 shows a flow chart of the inventive business method;

FIG. 2 shows an additional flow chart of the present invention.

FIG. 3 shows representative demographic fields to be populated by a target consumer;

FIG. 4 shows a representative electronic work sheet for a business to identify a predetermined market segment.

### DETAILED DESCRIPTION OF THE INVENTION

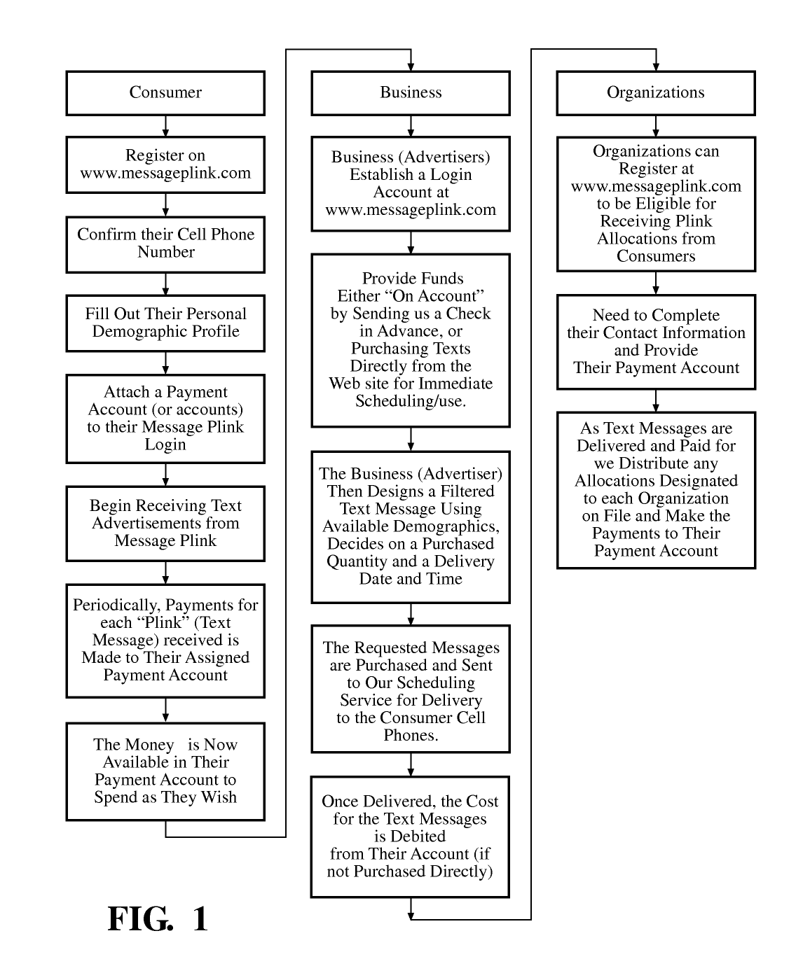

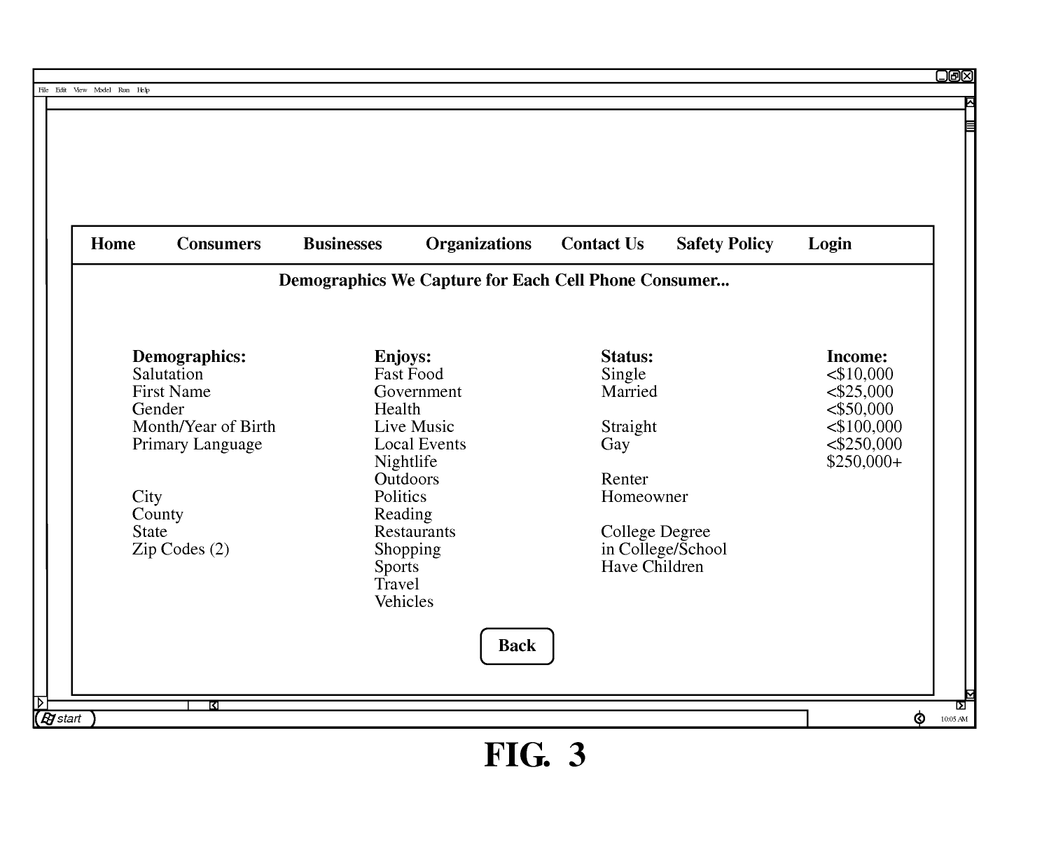

FIG. 1 of the present application shows a flow chart detailing populated fields of a computer database establishing market potentials for businesses seeking to market goods and services to consumers. First, the fields associated with the computer database are established where the fields are representative of desirable demographic characteristics. To initiate populating the fields, access is provided to the computer database to consumer enabling the consumers to populate the fields with their individual characteristic demographic information. The consumer can register through an internet web page such as, for example, messageplink.com by first providing and confirming a cell phone number to a mobile communications device. Next, the consumer fills out his/her characteristic personal demographic profile. An exemplary demographic profile is shown in FIG. 3. The profile shown in FIG. 3 is merely exemplary and should not be considered limiting because additional fields could be added to the demographic computer database if necessary. Initially, a consumer fills in salutation, first name, gender, date of birth and primary language along with an address further enabling a business to contact the consumer through the United States post.

Next, the consumer is prompted to identify interests such as, for example, fast food, government, health, live music or entertainment, interests in local events, night life, outdoors, politics, etc. Next, the consumer is prompted to identify personal status such as, for example, single, married, sexual preference, educational level, home ownership, etc. Additionally, consumer will be prompted to input income level in various ranges.

Referring again to FIG. 1, the consumer will be prompted to enter a payment method to receive remuneration, for example, in the form of currency by way of establishing access to an account. For example, PayPal® or an equivalent method such as debiting a credit card can be used to receive payment in currency or payment directly to a bank account. It is also contemplated that remuneration in the form of coupons or credits may also be provided to the consumer.

Once the consumer has established a demographic profile, he/she is ready to begin receiving text messages or the equivalent to a mobile communication device corresponding with the cell phone entered during the field population step.

Various payment schedules are arranged in cooperation with the business signaling the advertisement as further explained below, the consumer, and the computer database operator. For example, instant payment is wired to the consumer at the time an advertisement is received. Alternatively, periodic payments are arranged quarterly, monthly, or weekly. Once payment is received by the consumer, the consumer is able to spend the payment as desired, even at the business from which the advertisement is received.

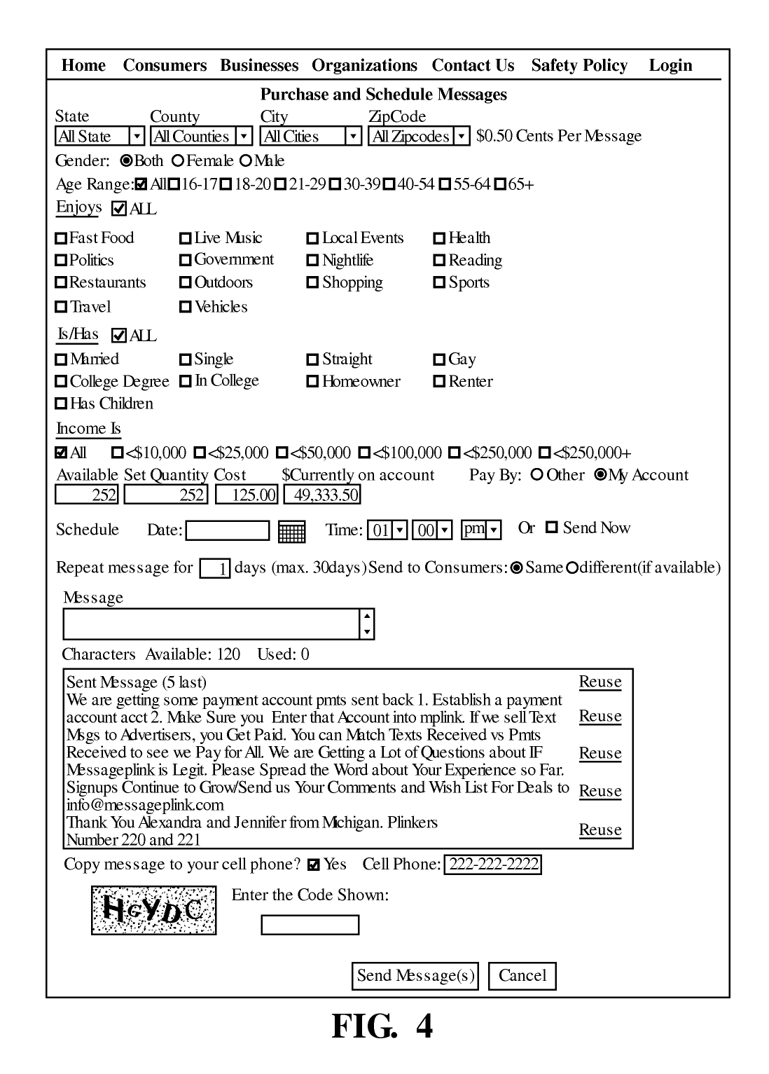

Businesses interested in advertising using the inventive method of marketing of the present application establish a login account at the same web address as does the consumer. The business is provided access to the computer database so that the business can identify its desirable demographic characteristics to identify its market potentials as best represented in FIG. 4. Businesses have the option of establishing an account and forwarding payment to the operator of the computer database or instantly paying on the web page via an electronic payment method at the time a text message or marketing message is sent to the consumers meeting the desired demographic characteristics.

Once the desired demographic characteristic is entered, the computer database is transformed into the predetermined market demographic so that the business can generate and transmit the electronic message to the focused demographic most likely to benefit from the business' goods and services. Once the transformation of the computer database has taken effect, the business can decide the number of messages sent, the time the messages are sent, and the date at which the messages are sent to the desired consumers. For example, the business can elect to send messages to each of the consumers that meet its desired demographic characteristic at the same time. Alternatively, the business can stagger the message transmissions over a period of days or weeks to more effectively budget its marketing dollars or balance the amount of consumers the business can service at a single time.

Once the messages are purchased, the message is sent to a scheduling service such as, for example, an SMS or short message service gateway for transmission to the consumer's cell phones. The SMS and gateway routes the messages to the selected cell phone numbers as directed by the inputs received from the computer database based upon the selected demographic characteristics. After the consumer has received the message, the business that initiated the transmission of the message to the consumer has its account debited for payment to the operator of the computer database and subsequently to the consumer receiving the text message.

Consumers are provided alternative avenues to receive and transfer payments for other remuneration received from the business causing the advertisement to be transmitted to the consumer's cell phone. For example, the consumer can elect to send all or a portion of the payments received to a third party organization such as, for example, a non-profit organization including, but not limited to, churches, charitable foundations, social services, homeless shelters, and the like. To be eligible to receive payment from the operator of the computer database, an organization must first register at the web page including providing payment account information acceptable to receive forwarded payments from the consumer. A consumer can elect to forward payments to multiple organizations so long as the organizations are registered through the computer database. Additionally, an organization could be the parent or family member paying for the cell phone service for a student or a dependent.

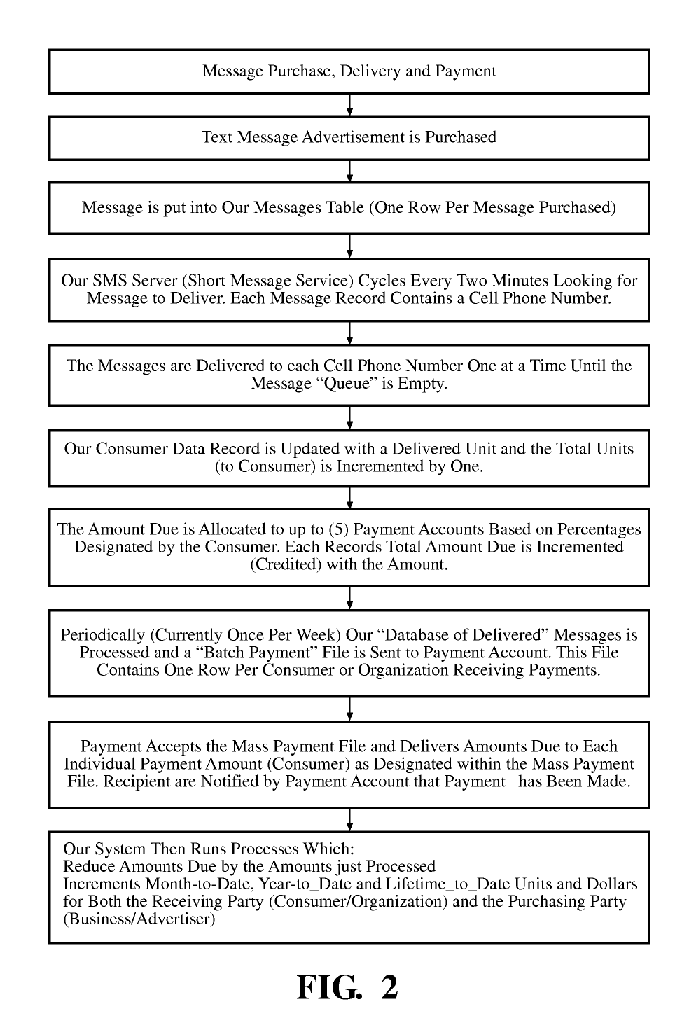

The process by which the computer database initiates messages to the consumer will now be explained as best represented in FIG. 2. Once a message has been purchased, the text message is created and put into a message table that is accessed by the short message service and periodic cycles, such as, for example, one, two or three minutes. The short message service looks for the message to deliver and associates the message with records containing the cell phone number registered by the consumer. The message is delivered by the short message service individually until the message queue or table is empty. Consumer data records are updated with the number of delivered messages by total message units by an increment of one unit each message. It should be understood to those of ordinary skill in the art that e-mail addresses may replace cell phone numbers to receive these messages if desired. The e-mail messages may be transmitted to either a mobile or a land based device as elected by the consumer. Amounts due to the consumer are allocated in a manner in which the consumer intends as set forth above in the explanation of organizations qualified to receive forwarded payments from the consumer. Periodically, a separate database established to identify delivered messages is accessed and batch payments are sent to the payment account identified by the consumer. The computer database tabulates amounts due, amounts processed, and date of payments for the consumer, the organization, and the business purchasing the advertisement.

The invention has been described in an illustrative manner, and it is to be understood that the terminology which has been used is intended to be in a nature of words a description rather than of limitation.

Obviously, many modifications and variations of the present invention are possible in light of the above teachings. It is, therefore, to be understood that within the scope of the appended claims, wherein referenced numerals are merely for convenience and are not to be in any way limiting, the invention may be practiced otherwise then as specifically described.

What is claimed is:

1. A method of marketing using mobile communication devices, comprising the steps of:
providing a computer database of market potentials;
establishing fields associated with said computer database, said fields being representative of demographic characteristics;
providing access to said computer data base to consumers enabling consumers to populate said fields with characteristic demographic information;
providing access to said computer database to businesses seeking to market goods and services to consumers having a predetermined demographic characteristic; and
transforming said computer database into market segments defined by the business' predetermined market demographic and generating and transmitting an electronic message to mobile communication devices owned by the consumers whose characteristic demographic information match the market segment defined by the business and providing remuneration to the consumer whose characteristic demographic information matches the market segment in response to the consumer receiving the electronic message.

2. The method set forth in claim 1, wherein said step of providing remuneration to the consumer is further defined by wiring currency to an account owned by the consumer.

3. The method set forth in claim 2, wherein said step of wiring money to an account owned by the consumer is further defined by wiring currency to a savings account, checking account, mobile payment service, or credit card.

4. The method set forth in claim 1, wherein said step of providing a computer database is further defined by an operator establishing said database and said demographic fields used to populate said database.

5. The method set forth in claim 4, further including the step of the business providing remuneration to the operator before the business transforms said database into market segments defined by the business' predetermined market demographic.

6. The method set forth in claim 1, wherein remuneration is paid to the consumers in at the time of receipt of the electronic message or periodically.

7. The method set forth in claim 1, wherein said step of transmitting an electronic message is further defined by transmitting text message.

8. The method set forth in claim 1, further including the step of the consumer electronically forwarding remuneration received from the business to a third party organization.

9. The method set forth in claim 8, wherein said step of forwarding remuneration received from the business to a third party organization is further defined by forwarding remuneration received from the business to a plurality of third party organizations.

10. The method set forth in claim 1, wherein the step of transmitting an electronic message to mobile communication devices owned by the consumers is further defined by cuing transmission of the electronic message to be delivered to consumers mobile communication devices in predetermined time segments.

11. The method set forth in claim 1, wherein said step of transmitting an electronic message is further defined by an operator of the computer database forwarding the electronic message to a short message service for scheduled delivery to the mobile communication device of the consumer matching desired demographic characteristics of predetermined by the business.

12. The method set forth in claim 1, further including the step of tracking messaging and payments made and received at periodic intervals.
